(19) United States
(12) Patent Application Publication
(10) Pub. No.: US 2008/0089437 A1
(43) Pub. Date: Apr. 17, 2008

(54) Method and apparatus for reducing peak-to-average power ratio of a signal

(75) Inventors: Frank Frederiksen, Klarup (DK); Troels Kolding, Klarup (DK); Peter Muszynski, Espoo (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/647,616

(22) Filed: Dec. 29, 2006

(30) Foreign Application Priority Data
Oct. 11, 2006 (GB) 0620158.6

(51) Int. Cl. H04L 25/03

(52) U.S. Cl. 375/296

(57) ABSTRACT

Peak-to-average power ratio of a signal which has a plurality of components is detailed. An exemplary method, apparatus and embodied computer program distribute the reduction in peak-to-average power ratio over the components of the signal in a non-even manner, taking into account the effect of reducing the peak-to-average power ratio of each component on the quality of the resultant signal.

### CROSS REFERENCE TO RELATED APPLICATION

This application claims priority to UK Application No. GB 0620158.6, filed on Oct. 11, 2006 and entitled the same as this application. The contents of that UK application are herein incorporated by reference.

### FIELD OF THE INVENTION

This invention relates to a method and apparatus for reducing peak-to-average power ratio of a signal. Aspects of the invention relate to a method and apparatus for reducing peak-to-average power ratio of signals in a telecommunications network, and may be implemented as, for example, a network entity, a transmitter, and a user equipment adapted to reduce the peak-to-average power ratio of a signal.

### BACKGROUND

Reducing peak-to-average power ratio of a signal is known in the art. Such a technique can be used, for example, to facilitate efficient power amplifier operation. The peak-to-average power ratio is advantageously reduced so that the required amount of power amplifier output back-off is reduced. There exists several known ways of reducing the peak-to-average power ratio of a signal ranging from clipping methods to tone reservation, pre-distortion, and randomisation methods.

One problem with reducing the peak-to-average power ratio of a transmitted signal is that information/data can be lost and data error probabilities can increase thus impacting on a system's performance.

The present invention aims to address the aforementioned problem.

### SUMMARY

According to an embodiment there is provided a method that includes inputting a signal that has at least two separate components; and distributing a reduction in peak-to-average power ratio over the components of the signal in a non-even manner, taking into account an effect of reducing the peak-to-average power ratio of each component on a quality of a resultant signal.

According to another embodiment there is an apparatus that includes a power amplifier having an input coupled to an output of a peak to average power ratio reduction PAPR block. The PAPR block is adapted to distribute a reduction in peak-to-average power ratio over different components of a signal in a non-even manner, taking into account an effect of reducing the peak-to-average power ratio of each component on a quality of a resultant signal.

According to another embodiment there is provided an embodied computer program of machine readable instructions particularly adapted to perform actions directed toward adjusting a peak to average power ratio by distributing a reduction in peak-to-average power ratio over at least two separate components of a signal in a non-even manner. Specifically, the distributing in a non-even manner takes into account an effect of reducing a peak-to-average power ratio of each component on a quality of a resultant signal.

These and other aspects are detailed more fully below.

### BRIEF DESCRIPTION OF THE FIGURES

For a better understanding of the embodiments and to show how the same may be carried into effect, certain embodiments of the present invention will now be described by way of example only with reference to the accompanying drawings.

FIG. 1 is a block diagram showing certain elements of a UMTS network in communication with a user equipment UE.

FIG. 2 is a block diagram illustrating certain elements of a EUTRAN network.

FIG. 3 is a block diagram showing elements and functions of a QoS-aware PAPR reduction scheme according to an embodiment of the invention.

FIG. 4 is a block diagram showing additional hardware for executing sub-functionalities within the QoS-aware PAPR reduction element shown in FIG. 3.

FIG. 5 shows a simplified illustration of a one-shot (single pass) clipping arrangement.

FIG. 6 is a graph illustrating performance of different modulation and coding schemes as a function of the clipping level.

FIG. 7 is a graph showing normalized performance of different modulation schemes for a low coding rate.

FIG. 8 is a graph showing normalized performance of different modulation schemes for a high coding rate.

FIG. 9 is a block diagram showing major elements of certain components shown in FIGS. 1-2.

### DETAILED DESCRIPTION

In many systems, a signal comprises a number of different components, each component having different characteristics. The total signal can be represented as a superposition of the different components. In known methods, when the peak-to-average power ratio of such a multi-component signal is reduced, the reduction in the peak-to-average power ratio of the signal is distributed evenly over the components of the signal.

The present inventors have realized that, because of their different characteristics, the different components of a signal will be affected differently by reducing their peak-to-average power ratio. That is, reducing the peak-to-average power ratio of certain components of a signal will have a large impact on the performance of a system whereas reducing the peak-to-average power ratio of other components of the signal will have little impact on the performance of the system. This may be due to a components importance on the performance of the system and/or a components susceptibility to a reduction in its peak-to-average power ratio in relation to data loss and an increase in the probability of data errors being introduced.

In light of the above, the present inventors have realised that in order to reduce the peak-to-average power ratio of a signal which has multiple components, while not unduly affecting the performance of a system, the reduction in power of the signal should not be distributed evenly over the components of the signal but rather should be distributed over the components taking account of the effect of reducing the power of each component on the signal and its effect on the performance of the system. Some component's peak-to-average power ratio will be reduced more than others. Some component's peak-to-average power ratio may not be reduced at all.

Preferably, the signal is separated into streams and each stream's peak-to-average power ratio is reduced taking into account the effect of this reduction on the signal. The signal may be separated into streams according to a range of different characteristics of the streams. For example, the signal may be separated into streams according to each component's assessed sensitivity towards distortion, according to a type of service to which each stream is associated (e.g. Voice over Internet Protocol (VoIP) over background), and/or according to a priority of each stream/user. Other possible characteristics for separating the signal into streams may also be envisaged.

The distribution of the reduction in peak-to-average power ratio over the components of the signal in accordance with certain embodiments may be referred to as the peak-to-average power ratio (PAPR) reduction scheme. Each stream may be characterized by one or more parameters of relevance to the PAPR reduction scheme. Such parameters could include, but are not limited to:
Used modulation scheme for the stream. The present inventors have found that some modulations are more sensitive to distortion than others. In principle, and depending on the allowed amount of complexity, the used code rate could also be specified.
Criticality of increasing block error probability (BLEP) for the stream. This could be specified as a maximum BLEP that is tolerated or by a cost function (priority factor) of exceeding the target BLEP due to distortion.

For example, a signal could be split into three streams as follows:
Control signals transmitted with robust modulation but where the BLEP performance is critical (loss of this signal may yield associated losses in data reception).
Data signals for high-SINR (signal to interference-plus-noise ratio) users utilizing low-level encoding and high order modulation (e.g. Quadrature Amplitude Modulation—QAM). The degradation of these signals due to amplitude clipping involves a significant loss in BLEP performance.
Data signals for low-SINR users utilizing high-level encoding and the use of a SINR robust modulation scheme. These signals may be less susceptible to clipping and amplitude distortion (and the impact on system performance may be less) compared to e.g. the above two streams.

According to an embodiment, the peak-to-average power ratio of the third stream in the above example should be reduced more than the first and second streams in order to achieve a suitable reduction in the peak-to-average power ratio of the overall signal while limiting problems of BLEP increase and/or impact on system performance.

PAPR-reduction schemes that are blind to the above issues (e.g. the importance of the component of the signal and/or the susceptibility of the component of the signal to a reduction in the peak-to-average power ratio by, for example, clipping) will tend to distribute the “clipping” effect evenly but not the impact at system level. This is not the case in embodiments in which the “clipping” effect is distributed such that the impact at a system level is spread more evenly over the components of a signal. In effect, the PAPR reduction schemes of embodiments are Quality-of-Service-Aware (QoS-Aware). That is, the quality of reception and impact on system/stream level performance are taken into account. QoS/stream-aware clipping methods according to embodiments can thus achieve efficient power amplifier operation while minimizing impact of impairments on system/stream level performance. In this way, it is possible to reduce the performance of low-quality services before the performance of high-quality services is reduced.

According to another embodiment there is provided a network element adapted to perform the method described herein.

According to another embodiment there is provided a telecommunications network comprising the network element and a plurality of mobile user equipment.

According to another embodiment there is provided a computer program, embodied on a computer readable medium, that includes program code means adapted to perform the method described herein when the program is run on a computer or on a processor.

According to another embodiment there is provided a computer program product that includes program code means stored in a computer readable medium, the program code means being adapted to perform any of steps of method described herein when the program is run on a computer or on a processor.

It will be understood that in the following description the present invention is described with reference to particular non-limiting examples from which the invention can be best understood. The invention, however, is not limited to such examples.

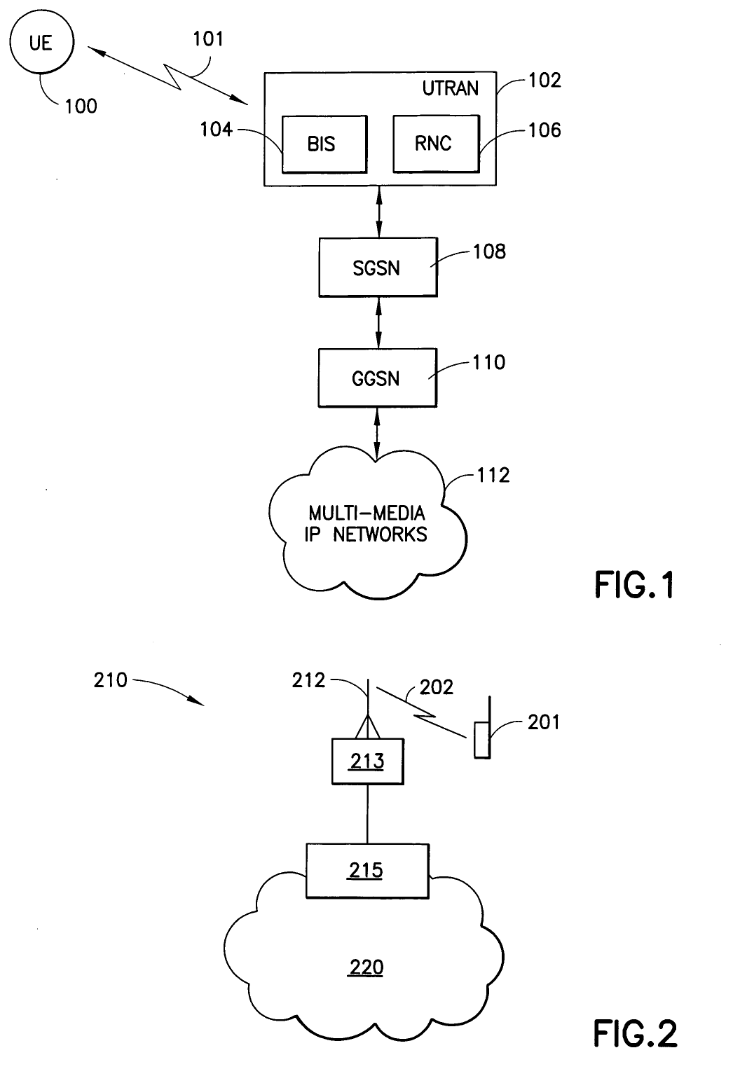

Embodiments of the present invention can be applied generally to systems where different data/control streams are transmitted simultaneously and where power amplifier efficiency is important. An example of such a system is a Universal Mobile Telecommunications System (UMTS) network and a UE in communication with that network. Referring to FIG. 1, there is illustrated the main elements of a UMTS network. It should be noted that FIG. 1 does not represent a full implementation of a UMTS network, which implementation will be familiar to one skilled in the art. Rather, FIG. 1 represents some of the main elements of such a UMTS network for placing embodiments of the invention into an appropriate context.

A user equipment (UE) 100 communicates over a radio interface 101 with a UTRAN (UMTS radio access network) 102. As is known in the art, the UTRAN 102 includes a base transceiver station (BTS) 104 and a radio network controller (RNC) 106. In the UMTS network the UTRAN 102 is connected to a serving General Packet Radio Service (GPRS) support node (SGSN) 108, which in turn is connected to a gateway GPRS support node (GGSN) 110. The GGSN 110 is further connected to at least one external network, e.g. multimedia IP network, represented by reference numeral 112 in FIG. 1. Both the SGSN 108 and the GGSN 110 may be considered to be network elements.

FIG. 2 shows another non-limiting example of mobile architectures, whereto embodiments of principles of these teachings may be applied, is known as the Evolved Universal Terrestrial Radio Access (E-UTRA). An exemplifying implementation is therefore now described in the framework of an Evolved Universal Mobile Telecommunication System (UMTS) Terrestrial Radio Access Network (E-UTRAN). An Evolved Universal Terrestrial Radio Access Network (E-UTRAN) consists of E-UTRAN Node Bs (eNBs) which are configured to provide both base station and control functionalities of the radio access network. The eNBs may provide E-UTRA features such as user plane radio link control/medium access control/physical layer protocol (RLC/MAC/PHY) and control plane radio resource control (RRC) protocol terminations towards the mobile devices. It is noted, however, that the E-UTRAN is only given as an example and that the method can be embodied in any access system or combination of access systems.

A communication device can be used for accessing various services and/or applications provided via a communication system as shown in FIG. 2. In wireless or mobile systems the access is provided via an access interface between a mobile communication device 201 and an appropriate wireless access system 210. A mobile device 201 can typically access wirelessly a communication system via at least one base station 212 or similar wireless transmitter and/or receiver node. Non-limiting examples of appropriate access nodes are a base station of a cellular system and a base station of a wireless local area network (WLAN). Each mobile device 201 may have one or more radio channels 202 open at the same time and may receive signals from more than one base station.

A base station is typically controlled by at least one appropriate controller entity 213 so as to enable operation thereof and management of mobile devices in communication with the base station. The controller entity is typically provided with memory capacity and at least one data processor. In FIG. 2 the base station node 212 is connected to a data network 220 via an appropriate gateway 215. A gateway function between the access system and another network such as a packet data network may be provided by means of any appropriate gateway node 215, for example a packet data gateway and/or an access gateway.

The following exemplification is given for the downlink direction (i.e. from a base transceiver station (or Node B as it may be called in some systems) to user equipment (UE)) where orthogonal frequency-division multiple access (OFDMA) is used. However, embodiments of this invention could also be applied in the uplink (i.e. from the user equipment to the base station) where power efficiency is also very important and where multiple data streams are transmitted simultaneously (e.g. different streams with different BLEP targets or different streams using different modulation). Aspects of the invention can in general be applied to any system, where the resulting time domain signal can be represented as a superposition of a set of user streams with different requirements. It is envisaged that embodiments of the invention can improve competitiveness of, for example, Node-B and UE products. It is assumed that overall, the UE or Node-B needs to comply with some predefined test cases, and that the present invention can allow fulfillment these requirements with less output back-off (OBO).

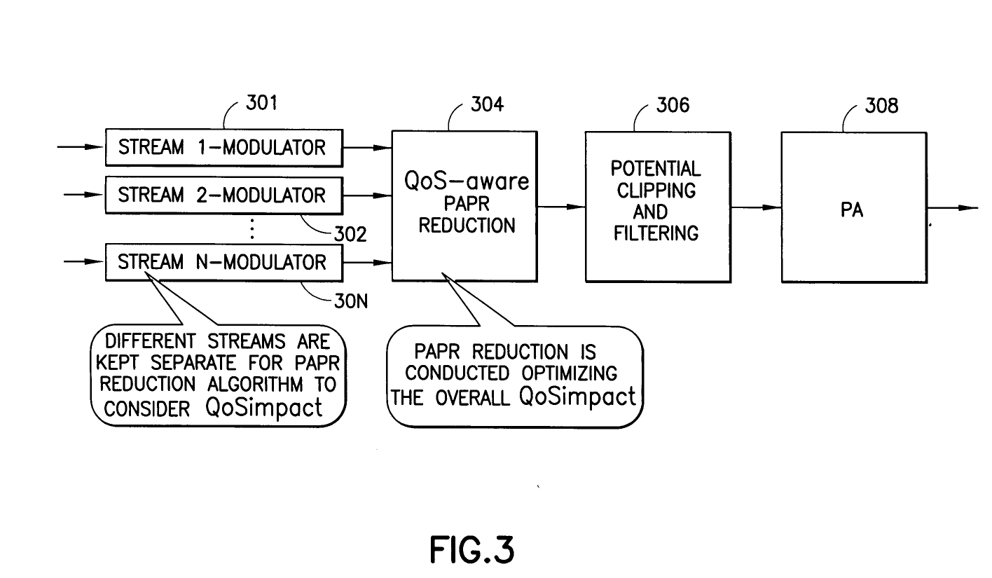

Each stream of a signal is fed from parallel modulators 301, 302, 30N into an apparatus or block 304 conducting the QoS-Aware PAPR reduction as shown in FIG. 3. In an OFDM system, the input from each stream contains the time domain representation of the individual stream, that is, the IFFT (Inverse Fast Fourier Transform) operations for OFDM have already been performed.

The PAPR reduction at block 304 is conducted from knowledge of the impact on the different streams and when a satisfactory result is achieved, the new and distorted data stream (now combined) is fed forward to a power amplifier 308 for subsequent transmission. In the case that the clipping unit is ‘non-intelligent’, it will clip the signal without any knowledge of the final output signal. In this case, a clipping unit 306 is disposed after the per-stream summation at block 304 of the clipped signals and before the power amplifier 308 is desirable. Furthermore, a filtering circuit (illustrated as within the clipping unit 306) is desirable at this point to reduce spectral re-growth, since the clipping process will typically introduce this.

As the clipping algorithm will do the signal modifications on the time domain signal components to be transmitted, and since the algorithm does not require any a priori knowledge of the PAPR reduction algorithm, no additional control signalling needs to be given to the receiving UE.

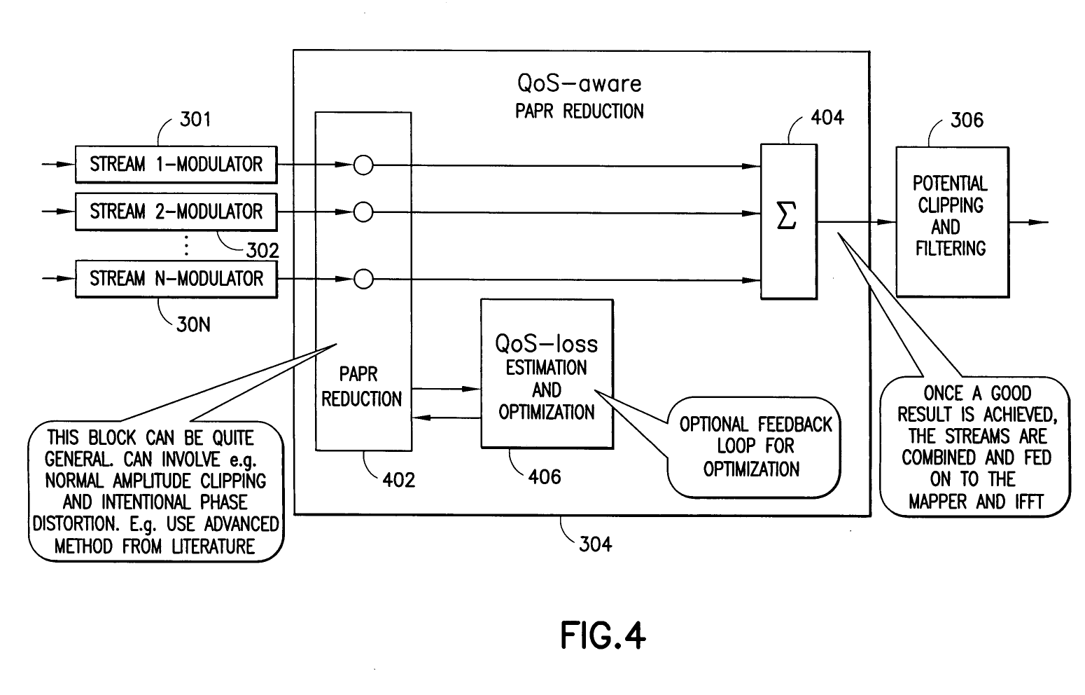

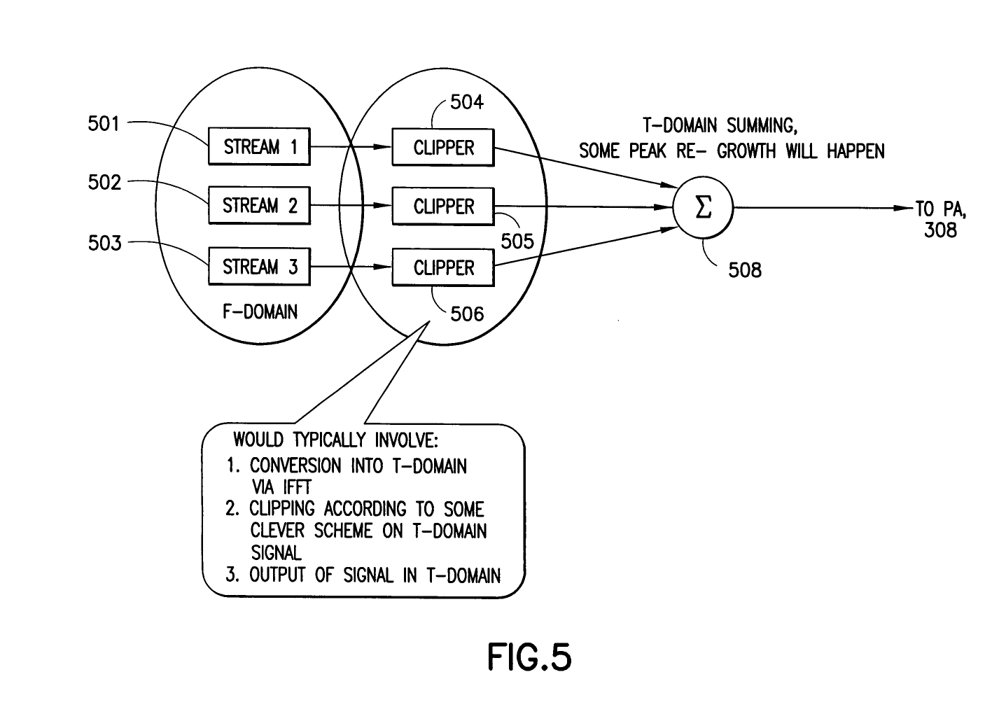

The exact implementation can vary from being very complex to being very simple. In the following, an example of a simple implementation and its operation is given. First, the general concept of FIGS. 3 and 4 is described.

The different time domain streams from parallel modulators 301, 302, 30N are fed as input to the QoS-Aware PAPR reduction block 304 and are influenced by the PAPR reduction algorithm, embodied in FIG. 4 as an application specific integrated circuit ASIC, field programmable gated array FPGA, or other processor 402 that executes the PAPR reduction algorithm on the various input streams. The PAPR reduction algorithm 402 can in principle utilize known methods from the literature ranging from simple to advanced methods. When the streams are modified they are summed at a combiner 404 and the QoS-Aware PAPR reduction block 304 keeps track of what quality loss is experienced within each of the streams. This tracking is indicated by the arrow going from the PAPR reduction block/ASIC/FPGA 402 to the QoS loss estimation unit 406 in FIG. 4. Here, the set-up is described as an iterative procedure, but in principle this could be a one-shot approach provided some simplifications are assumed.

The conceptual principle of a one-shot approach is shown in FIG. 5. There, parallel frequency domain streams 501, 502, 503 are input to respective clippers 504, 505, 506 that perform three functions. Each clipper 504-506 converts its input frequency domain signal into a time domain signal, clips (or not clips) its signal according to some schedule (similar to the algorithm used in the PAPR reduction ASIC/FPGA 402 of FIG. 4, but without the feedback block 406), and outputs the converted and clipped (or not clipped) signal to a combiner 508. At the combiner 508, the time-domain signals are summed, but since additional filtering is not shown in FIG. 5, some spectral re-growth can be expected. Alternatively, filtering may be added between the clippers 504-506 and the power amplifier 308 that is coupled to an output of the combiner 508.

An example of modulation-aware PAPR reduction is given below. This example is merely an example and many ways of forming the implementation exist.

### Modulation-Aware PAPR Reduction

Different signals are separated into streams depending on which type of modulation is used. For example, one Quaternary Phase-Shift Keying (QPSK) stream would include all the signals using QPSK modulation (e.g. control channels and data signals for different users). Without PAPR reduction, each stream may be described mathematically as

QPSK stream: s₄(t)=|α₄(t)|·exp(jθ₄(t)).

16 QAM stream: s₁₆(t)=|α₁₆(t)|·exp(jθ₁₆(t)).

64 QAM stream: s₆₄ (t)=|α₆₄(t)|·exp(jθ₆₄(t)).

In the above equations, s(t) is the time-domain signal, α represents signal amplitude, and θ represents signal phase. BPSK (Binary PSK), 8 PSK, etc. could be other options depending on what is supported by the system.

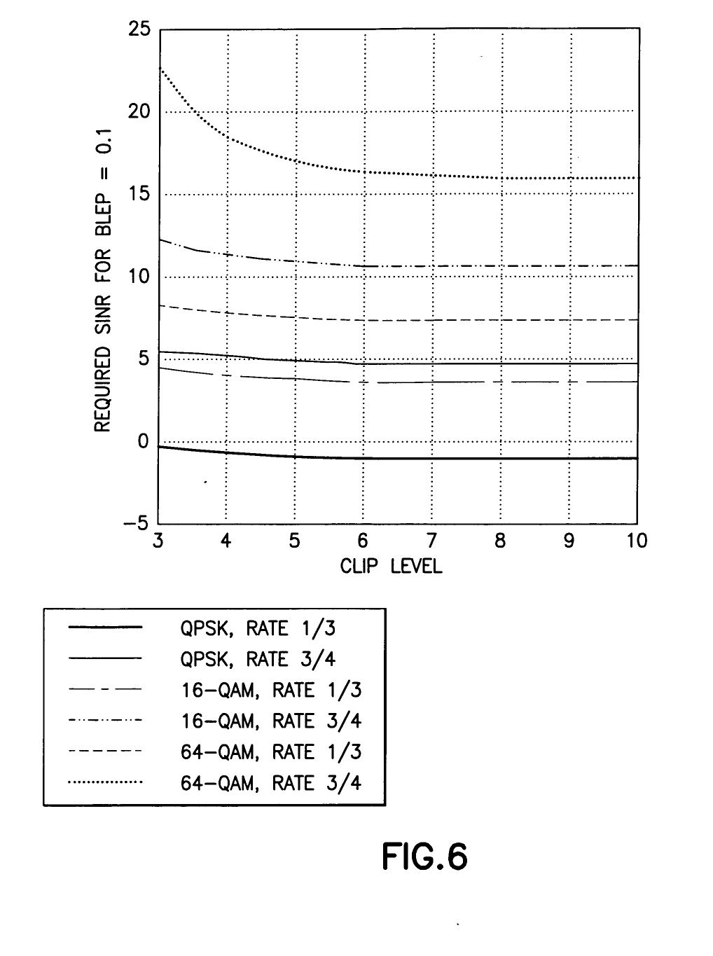

FIG. 6 illustrates the performance of different modulation and coding schemes as a function of the clipping level. The clipping level is defined such that any transmit sample exceeding the mean power+the clip level is saturated such that the amplitude is reduced, but the phase information is preserved.

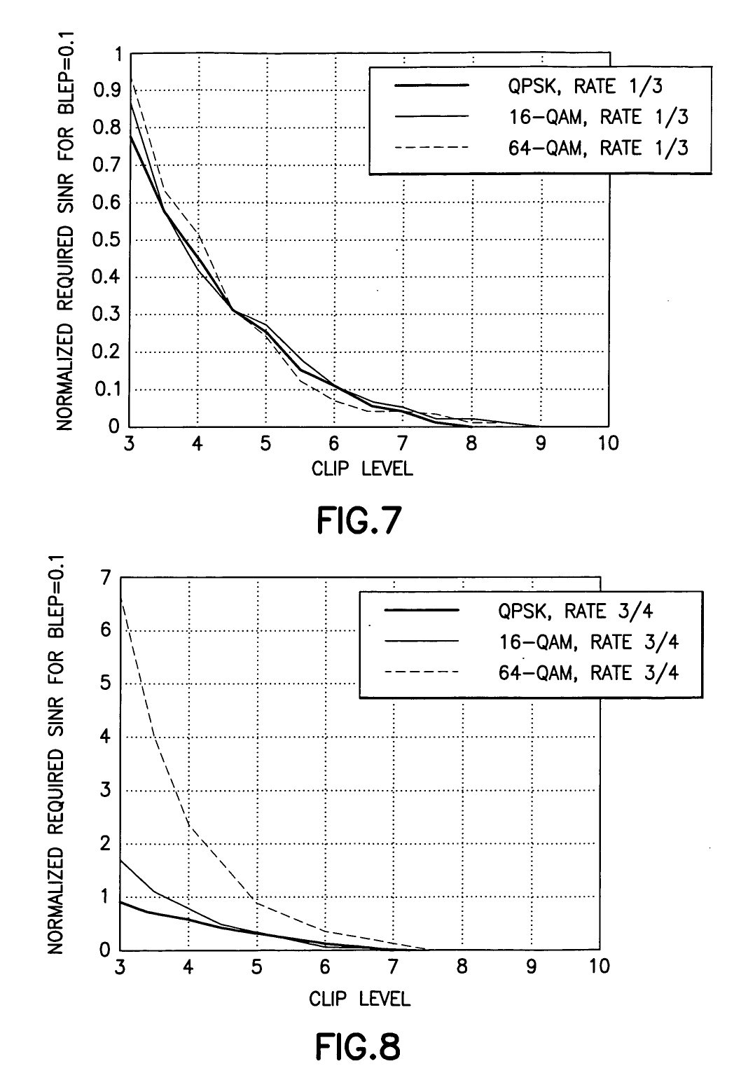

In the example shown here, the PAPR reduction scheme utilizes a priori information related to the sensitivity of the modulation scheme to amplitude distortion. Example distortion curves are given in FIG. 7 and FIG. 8 showing the relative degradation in BLEP as a function of the clipping ratio for each modulation scheme (different code rates used as example). FIG. 7 shows normalized performance of different modulation schemes for a low coding rate. The normalized required SINR is calculated based on the SINR requirement without clipping. For this situation, the strong coding will help all modulation schemes recover the effects from the clipping. FIG. 8 shows normalized performance of different modulation schemes for a high coding rate. The normalized required SINR is calculated based on the SINR requirement without clipping. For this situation, it is seen that reducing the forward error correction coding results in a larger SINR requirement for higher order modulations.

Expanding the algorithm further, also the code rate could be used to define the PAPR reduction method. However, from a spectral efficiency viewpoint, higher order modulation is not usually used together with low code rates and so the impact may be quite accurately read using FIG. 8 alone.

The target is to adjust the PAPR reduction function for each stream until the point when the total transmit signal fits within the available PA dynamic range (with some outage). For example, the total signal for the present example becomes:

$${s}_{TOT} ( t ) = {\sum }_{N ∈ \{ 4 , 16 , 64 \}} {f}_{N} ( \vert {α}_{N} ( t ) \vert \cdot exp ( j {θ}_{N} ( t ) ) )$$

where the function f_{N}(x) denotes the PAPR reduction for each scheme and N represents the different code-rate streams. In this very simple example, it is assumed that the amplitude is lowered without distorting the phase of each stream such that

f_{N}(x)=max{|x|,W_{N}}·exp(j∠x)

where W_{N} denotes the maximum limiting amplitude for stream N. The optimization task is now to select the values W₄, W₁₆, and W₆₄ such that the signal quality degradation of the different streams is balanced. Here, both the amplitude and phase of the individual streams need to be considered carefully. In the solution two criteria need to be observed:
The combined W_{N} values need to facilitate an overall amplitude reduction of the total signal so as to avoid hard-clipping in the PA (with some outage).
The relative ratio among the W_{N} parameters should be such that the relative BLEP degradation of the streams is the same (with the help of local performance graphs such as the ones shown in FIG. 7 and FIG. 8).

This constitutes an equation set comprising two equations and two unknowns (since the W_{N}'s are tied together and their total contribution is limited by the maximum available output power of the PA before clipping).

A simplified approach to the problem would be to consider the one-shot approach (such as shown by example in FIG. 5) where one or more signal sources are to be potentially clipped. However, to reduce the risk of increasing the amplitude of the resulting signal, clipping should only be performed on signals that are approximately co-phased with the resulting signal (after the addition of the sources). Consider the signal ‘s’, which is a summation of the signals from 3 sources:

s=(i1+j*q1)+(i2+j*q2)+(i3+j*q3)=a1*ê(j*p1)+a2*ê(j*p2)+a3*ê(j*p3)=a0*ê(j*p0)

Now, only stream ‘1’ would/should be clipped if the service allows this, and provided that (at the same time) the phase of stream 1 is such that it will actually provide a reduction of the total transmitted amplitude. That is, stream 1 should have approximately the same phase as the resulting output signal (+/−45 degrees). A similar argument applies for the other streams.

In addition to the advantage of balancing the PAPR reduction impact related to the importance of the transmitted data, another advantage of embodiments of the invention is that no a priori information is needed at the receiving end, thus operating without the need for additional control information transmitted over the air interface. One disadvantage is that the approach requires more computational load at the transmitting end. Also, depending on how much QoS information will be used in the clipper, some information may need to be exchanged between layers in the system (e.g. from higher layers to the physical layer).

The required data processing functions may be provided by means of one or more data processor entities. All required processing may be provided in the mobile user equipment or a network element such as the base station transceiver/Node B or equivalent. Appropriately adapted computer program code product may be used for implementing the embodiments, when loaded to a computer or processor. The program code product for providing the operation may be stored on and provided by means of a carrier medium such as a carrier disc, card or tape. A possibility is to download the program code product via a data network. Implementation may be provided with appropriate software.

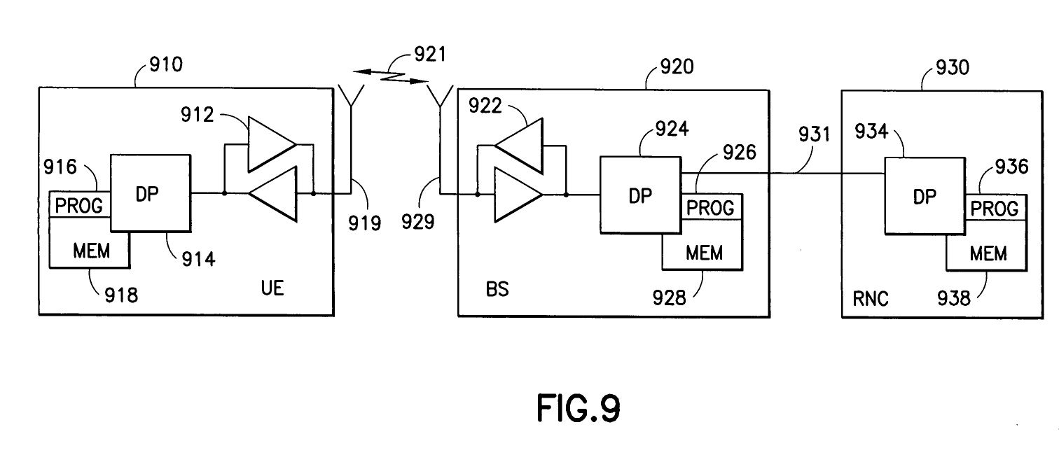

FIG. 9 is a schematic block diagram of a base station BS 920 in which the present invention may be embodied. The present invention may be disposed in any host computing device having a wireless link 921 to another node, whether or not that wireless link is cellular/PCS, IP protocol, WLAN, or the like. Shown is a user equipment/mobile station UE 910 and a radio network controller 930, with the wireless link 921 between the UE 910 and the BS 920. The link 931 between the BS 920 and higher nodes in the network, such as the RNC 930, is typically a wireline link though in some instances it also may be wireless. The two network nodes 920, 930 of FIG. 9 are analogous to the BTS 104/RNC 106 and e-Node B 212/gateway 215 of FIGS. 1-2.

The BS 920 includes a transceiver 922, a processor 924, and a computer readable memory 928 for storing software programs 926 of computer instructions executable by the processor 924 for performing actions related to this invention. The BS 920 further has an antenna 929 for sending and receiving wireless signals modified according to embodiments of this invention. The UE 910 and the RNC 930 have some similar components, indicated in the MS 910 as a transceiver 3912, processor 914, memory 918 and programs 916; and in the RNC 930 as a processor 934, memory 938 and programs 936. Though not shown, if the link 931 between the BS 920 and the RNC 930 is wireless, the RNC 930 will also include a transceiver and an antenna, and in some networks the higher node (represented by the RNC 930) may communicate directly (and wirelessly) with the UE 910.

The component blocks illustrated in FIG. 9 are functional and the functions described below may or may not be performed by a single physical entity as described above. For example, the processor that executes the PAPR reduction algorithm may be a general processor that executes other unrelated functions, or it may be an ASIC or FPGA. The BS 920 or UE 910 may include multiple transmitters and multiple receivers, each selectively coupled to more than one, and preferably all, of its antenna elements.

The embodiments of this invention may be implemented by computer software executable by a data processor of the BS 920, the UE 910, or other host device, such as the processor 924, 914, 934, or by hardware, or by a combination of software and hardware. Further in this regard it should be noted that the various blocks of the diagrams of FIGS. 3 through 5 may represent program steps, or interconnected logic circuits, blocks and functions, or a combination of program steps and logic circuits, blocks and functions.

The memory or memories 918, 928, 938 may be of any type suitable to the local technical environment and may be implemented using any suitable data storage technology, such as semiconductor-based memory devices, magnetic memory devices and systems, optical memory devices and systems, fixed memory and removable memory. The data processor(s) 914, 924, 934 may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

While this invention has been particularly shown and described with reference to exemplary embodiments, it will be understood to those skilled in the art that various changes in form and detail may be made without departing from the scope of the invention as defined by the appended claims.

1. A method comprising:
inputting a signal that comprises at least two separate components; and
distributing a reduction in peak-to-average power ratio over the components of the signal in a non-even manner taking into account an effect of reducing the peak-to-average power ratio of each component on a quality of a resultant signal.

2. A method according to claim 1, wherein the reduction in peak-to-average power ratio is distributed over the components of the signal according to a priority assigned to each component.

3. A method according to claim 1, wherein the reduction in peak-to-average power ratio is distributed over the components of the signal according to susceptibility of each component to a reduction in its peak-to-average power ratio.

4. A method according to claim 1, wherein each component comprises a stream and the resultant signal comprises one of a combined or a transmitted signal.

5. A method according to claim 4, wherein inputting the signal comprises dividing the signal into streams according to each component's assessed sensitivity towards distortion, according to at least one of: a type of service to which each stream is associated and a priority of each stream.

6. A method according to claim 4, wherein each stream is distinguished from each other stream by at least one parameter that reflects sensitivity of the stream to peak-to-average power ratio reduction.

7. A method according to claim 6, wherein the at least one parameter is selected from: stream modulation scheme and error probability for the stream due to peak-to-average power ratio reduction.

8. A method according to claim 7, wherein the error probability comprises a block error probability.

9. A method according to claim 7, wherein the at least one parameter comprises at least one of: a maximum error probability and a priority factor for exceeding a target error probability.

10. A method according to claim 1, wherein distributing the peak-to-average power ratio comprises adjusting the peak-to-average power ratio of each component until a target value for the reduction in the peak-to-average power ratio of the resultant signal is attained.

11. A method according to claim 1, wherein distributing the reduction in peak-to-average power ratio over the components comprises an iterative reduction.

12. A method according to claim 1, further comprising, after distributing the reduction in peak-to-average power ratio over the components of the signal, combining the components into the resultant signal and outputting the resultant signal to a power amplifier.

13. A method according to claim 12, further comprising reducing the peak-to-average power ratio of the resultant signal prior to outputting the resultant signal to the power amplifier.

14. A method according to claim 12, further comprising filtering the resultant signal through a filtering circuit prior to outputting to the power amplifier.

15. An apparatus comprising:
a power amplifier; and
a peak to average power reduction PAPR block having an output coupled to an input of the power amplifier, the PAPR block adapted to distribute a reduction in peak-to-average power ratio over different components of a signal in a non-even manner taking into account an effect of reducing the peak-to-average power ratio of each component on a quality of a resultant signal.

16. An apparatus according to claim 15, wherein the PAPR block comprises a plurality of inputs each arranged to receive a respective one of the different components of the signal and a processor for distributing the reduction in peak-to-average power ratio over the components of the signal, and the apparatus further comprising a combiner for combining the components into the resultant signal.

17. An apparatus according to claim 16, further comprising a feedback loop disposed between the combiner and the processor, the feedback loop comprising a quality-of-service loss estimator.

18. An apparatus according to claim 15, further comprising an additional processor arranged to receive the resultant signal from the combiner and reduce the peak-to-average power ratio of the resultant signal.

19. An apparatus according to claim 15, further comprising a filtering circuit having an output coupled to an input of the power amplifier and arranged to filter the resultant signal.

20. A transmitter comprising the apparatus according to claim 15.

21. A mobile user equipment comprising the transmitter of claim 20.

22. A network element of a telecommunications network comprising the transmitter of claim 20.

23. A telecommunications network comprising the network element of claim 22 and a plurality of mobile user equipment.

24. A program of machine-readable instructions, tangibly embodied on an information bearing medium and executable by a digital data processor, to perform actions directed toward adjusting a peak to average power ratio, the actions comprising:
distributing a reduction in peak-to-average power ratio over at least two separate components of a signal in a non-even manner taking into account an effect of reducing a peak-to-average power ratio of each component on a quality of a resultant signal.

25. The program of claim 24, wherein the reduction in peak-to-average power ratio is distributed over the components of the signal according to a priority assigned to each component.

26. The program of claim 24, wherein the reduction in peak-to-average power ratio is distributed over the components of the signal according to susceptibility of each component to a reduction in its peak-to-average power ratio.

27. The program of claim 24, wherein each component comprises a stream and the resultant signal comprises one of a combined or a transmitted signal.

28. The program of claim 27, wherein each stream is distinguished from each other stream by at least one parameter that reflects sensitivity of the stream to peak-to-average power ratio reduction.

29. The program of claim 28, wherein the at least one parameter is selected from: stream modulation scheme and error probability for the stream due to peak-to-average power ratio reduction.

30. The program of claim 24, wherein distributing a reduction in the peak-to-average power ratio comprises adjusting the peak-to-average power ratio of each component until a target value for the reduction in the peak-to-average power ratio of the resultant signal is attained.

31. The program of claim 30, wherein distributing the reduction in peak-to-average power ratio over the components comprises an iterative reduction.
